(19) United States
(12) Patent Application Publication
(10) Pub. No.: US 2024/0061716 A1
(43) Pub. Date: Feb. 22, 2024

(54) DATA CENTER WORKLOAD HOST SELECTION

(71) Applicant: International Business Machines Corporation, Armonk, NY (US)

(72) Inventors: Joshua Bennetone, Durham, NC (US); Al Chakra, Apex, NC (US); Kaji Rashad, Morrisville, NC (US)

(21) Appl. No.: 17/891,464

(22) Filed: Aug. 19, 2022

(51) Int. Cl. G06F 9/50

(52) U.S. Cl. CPC G06F 9/505; G06F 9/5077; G06F 2209/503; G06F 2209/508

(57) ABSTRACT

A system may include a memory and a processor in communication with the memory. The processor may be configured to perform operations. The operations may include identifying a priority of a workload and calculating a workload preference based on the priority. The operations may include selecting a host for the workload using the workload preference and deploying the workload to the host.

### BACKGROUND

The present disclosure relates to distributed systems, and, more specifically, to workload management in distributed systems.

Workload scheduling and workload distribution are common functions in the computer field, including in distributed systems. Distributed systems may include, for example, open-source container systems. Open-source containers offer adaptive load balancing, service registration, deployment, operation, resource scheduling, and capacity scaling.

Certain workloads, such as transient container applications, may temporarily use host resources such that a host may have additional resources available for one or more other workloads after its completion. A system management goal may be to maximize utilization of the system without negatively impacting performance. In distributed systems such as open-source container systems, this may include maximizing the use of existing hosts before initiating additional hosts.

### SUMMARY

Embodiments of the present disclosure include a system, computer-implemented method, and computer program product for data center workload host selection.

A system in accordance with the present disclosure may include a memory and a processor in communication with the memory. The processor may be configured to perform operations. The operations may include identifying a priority of a workload and calculating a workload preference based on the priority. The operations may include selecting a host for the workload using the workload preference and deploying the workload to the host.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a system for data center resource request host selection in accordance with some embodiments of the present disclosure.

FIG. 2 depicts a system for data center resource request host selection in accordance with some embodiments of the present disclosure.

FIG. 3 illustrates a system for data center resource request host selection in accordance with some embodiments of the present disclosure.

FIG. 4 depicts a computer-implemented method for data center resource request host selection in accordance with some embodiments of the present disclosure.

FIG. 5 illustrates a data center resource request host selection method in accordance with some embodiments of the present disclosure.

FIG. 6 illustrates a cloud computing environment in accordance with embodiments of the present disclosure.

FIG. 7 depicts abstraction model layers in accordance with embodiments of the present disclosure.

FIG. 8 illustrates a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to distributed systems, and, more specifically, to workload management in distributed systems.

A system management goal may be to maximize utilization of the system without negatively impacting performance; in distributed systems, this may include maximizing the use of existing hosts before initiating any additional hosts. Certain workloads, such as transient container applications, may temporarily use host resources such that a host may have additional resources available for one or more other workloads after its completion. In some embodiments of the present disclosure, a system may be implemented to identify and maximize the utility of resources including those currently available, pending availability, and available in the future.

In accordance with the present disclosure, a prediction may be made such that a system autonomous load balancer (otherwise referred to as the decision engine), which is the component that decides where a container could live and on which host, may be notified of a current or pending container deletion (or deprovision). The autonomous load balancer may select a host for the container based, in whole or in part, on the deletion of another container and upcoming resource availability resulting therefrom.

In accordance with the present disclosure, selecting a data center node to host a workload may involve considering the current state and availability of resources (e.g., available data storage) as well as resources that will become available later (e.g., within a timeframe predetermined by a user). A desired host may be selected factoring in soon-to-be-available resources based on, for example, containers pending destruction and/or in the destruction process, queue, or phase. Learned patterns such as machine learning (ML) analytics, deployment and execution time analytics for a given container type, and the like may be used for the selection.

In accordance with the present disclosure, a distributed system may consider various scenarios and factors pertinent to each workload deployment. For example, a distributed system may have a pending workload request; the system may have one active node at capacity (e.g., the data storage allocated to the node is currently fully utilized by existing workloads), a node in the midst of the destruction, and additional nodes pending destruction.

The destruction of a node may take, for example, five seconds; in accordance with the present disclosure, the node in the midst of destruction may be salvaged before the five seconds expires and considered as a candidate for the pending workload request, and/or the nodes pending destruction may be considered as candidates for the pending workload request. Considering nodes in the destruction phase and/or pending destruction may enable a system to assign a workload to a more optimal host. Specifically, the system may consider all available and pending available resources, identify a node pending destruction as the optimal node for the workload, reassign the status of the node from pending destruction to active, and assign the new workload to that node. Alternatively, if such a system did not have access to the nodes in the destruction phase or pending destruction, then the system may be required to host the workload on a less desirable node (e.g., launching and waiting for a new node that will be minimally utilized).

A container (e.g., a workload or a pod hosting one or more workloads) may free up resources when shut down or destroyed. Various indicators may be used to identify the terminal status of a container. Such terminal indicators may include, for example, a deletion request for a container, an administrative command for removal from an access list, the removal of a container endpoint from the service list, and the like. These terminal indicators may be used to identify that a container is in or pending the destruction phase, that the resources are or will soon become available, and that the system may reassign the container to active to accept a new workload.

In accordance with the present disclosure, various statistics may be used. For example, the pod deploy time is the average amount of time it takes to deploy a pod on a given node. For example, the pod destroy time is the average amount of time it takes to destroy a pod on a given node. For example, the pod destroy start time is the time the destruction of a pod commenced or will commence. For example, the pod runtime is the average amount of time a pod will require to execute on a given node.

In accordance with the present disclosure, various principles may be used. For example, pods currently in the destroy phase on a given node may be identified with a tag such as, for example, “ActivePODsBeingDestroyed” or the like.

In accordance with the present disclosure, various priorities may be used to assist with scoring nodes for a given workload. Certain nodes may be better for some workloads whereas other nodes may be better for other workloads; specifically, one workload may need an optimal workload start time whereas another workload would be better suited to waiting for a node with additional processing capability (e.g., additional compute power). Priorities may be or include, for example, total time to deployment; a total time to deployment priority may consider any remaining time for destroying a pod in the destroy phase (e.g., an ActivePODsBeingDestroyed) and compare that with the time it would require to deploy a new pod. Priorities may be or include, for example, total time to complete execution of the workload; a complete execution of the workload priority may consider any remaining time for destroying a pod in the destroy phase (e.g., an ActivePODsBeingDestroyed) plus the workload runtime in the salvaged pod and compare that with the time it would require to deploy a new pod as well as the runtime in the new pod.

A command may contain information. For example, regarding statistics, the “kubectl describe” command may contain information satisfying a statistic of interest. Statistics of interest may include, for example, pod deploy time, pod destroy time, pod destroy start time, and/or pod runtime. The pod deploy time may be the time measured between the time of the initiation of the deployment and the time when the pod is prepared for a workload. In accordance with some embodiments of the present disclosure, the “kubectl describe” command may be enhanced to satisfy multiple or all statistics of interest.

A user may opt to use an ML mechanism for one or more gathered statistics. A running average may be computed on one or more statistics. The length of time (e.g., the number of days) used in the computation of the running average may be defined by an administrator (e.g., a user and/or developer). Given that additional data makes for better statistics, and that more data can be gathered by gathering it over a longer period of time, it may be preferable to define the length of time used for collecting the data and computing the running average as a sufficiently long period of time to generate a reasonably confident prediction, for example, a minimum of fourteen days (as in, equal to or greater than 336 hours). A confident prediction may include the selection of a node (e.g., selecting a preferable or optimal node) for a workload awaiting deployment (e.g., a newly generated pod awaiting node assignment).

In some embodiments of the present disclosure, a method may include mounting a persistent volume in a ReadWriteMany (RWX) access mode. The method may include allowing nodes to write statistics (e.g., the deploy time, destroy time, destroy start time, and/or the runtime) for each pod into the mounted persistent volume. The method may include the nodes writing the statistics for each pod onto the mounted persistent volume. The method may include the nodes repeating the writing of the statistics for a predefined set of iterations; the predefined set of iterations may be related to the length of time used for collecting the data (e.g., one or three iterations per day). The method may include generating a computed average statistical time information metric by averaging each of the statistics. The method may include using the computed average statistical time information metric as a metric for deploying a pod onto a node.

A system in accordance with the present disclosure may include a memory and a processor in communication with the processor, and the processor may be configured to perform operations. The operations may include selecting a data center host for container deployment based on pending container provision requests. The operations may include identifying a workload preference associated with a pending container provision request. The workload preference may include a priority to deploy a container on a host node capable of providing a fastest overall execution time for the container; the overall execution time may include the deployment time for the container. The workload preference may include a priority to deploy the container on a host node in which the container can be deployed the fastest. The workload preference may include multiple priorities, for example, a balancing of the priorities for minimizing the time until completion and for deploying the container the fastest. The operations may include selecting an optimal host node from a set of host nodes for deployment of the container based, in whole or in part, on the workload preference associated with the container provision request.

In some embodiments of the present disclosure, selecting the optimal host node for deployment of the container may include considering an optimal host node as having a future amount of required available resources within a predetermined future point in time. In some embodiments, selecting the optimal host node from the set of host nodes may include considering a delay in deploying the container until the optimal host node has the required resources available. In some embodiments, selecting the optimal host node may include considering an amount of time required to deploy the container on the optimal host node, including whether the amount of time is less than an amount of time required to deploy the container on a less optimal host node which currently has the required resources.

In some embodiments of the present disclosure, the operations may include determining a future amount of available resources on the host node within a predetermined future point in time. The determination may be based, in whole or in part, on resources freed up as a result of one or more containers deployed on the host node that will no longer require the resources. For example, the containers deployed on the host node may be in the destruction phase, or the destruction of the containers may be initiated and/or completed by the predetermined future point in time.

In some embodiments of the present disclosure, the operations may include identifying one or more containers on the host node whose destruction will be initiated within the predetermined period of time. This identification may be based, in whole or in part, on identifying a container destruction event trigger. The container destruction event trigger may be, for example, a deletion request for a running container, administrative commands such as removing a running container from an access list, and/or removing a container endpoint from a server list.

In some embodiments of the present disclosure, selecting the optimal host node from the set of host nodes for deployment of the container may be based on various factors. These factors may include an average amount of time required to deploy the container on the node, a destruction start time of a first container deployed on the node, an average amount of time required to destroy the first container deployed on the node, a future destruction start time of a second container deployed on the node, and/or an average amount of time required to destroy the second container deployed on the node.

A computer-implemented method in accordance with the present disclosure may include selecting a data center host for container deployment based on pending container provision requests. The method may include identifying a workload preference associated with a pending container provision request. The workload preference may include a priority to deploy a container on a host node capable of providing a fastest overall execution time for the container; the overall execution time may include the deployment time for the container. The workload preference may include a priority to deploy the container on a host node in which the container can be deployed the fastest. The workload preference may include multiple priorities, for example, a balancing of the priorities for minimizing the time until completion and for deploying the container the fastest. The method may include selecting an optimal host node from a set of host nodes for deployment of the container; the selection may be based, in whole or in part, on the workload preference associated with the container provision request.

In some embodiments of the present disclosure, selecting the optimal host node for deployment of the container may include considering an optimal host node as having a future amount of required available resources within a predetermined future point in time. In some embodiments, selecting the optimal host node from the set of host nodes may include considering a delay in deploying the container until the optimal host node has the required resources available. In some embodiments, selecting the optimal host node may include considering an amount of time required to deploy the container on the optimal host node, including whether the amount of time is less than an amount of time required to deploy the container on a less optimal host node which currently has the required resources.

In some embodiments of the present disclosure, the method may include determining a future amount of available resources on the host node within a predetermined future point in time. The determination may be based, in whole or in part, on resources freed up as a result of one or more containers deployed on the host node that will no longer require the resources. For example, the containers deployed on the host node may be in the destruction phase, or the destruction of the containers may be initiated and/or completed by the predetermined future point in time.

In some embodiments of the present disclosure, the method may include identifying one or more containers on the host node whose destruction will be initiated within the predetermined period of time. This identification may be based, in whole or in part, on identifying a container destruction event trigger. The container destruction event trigger may be, for example, a deletion request for a running container, administrative commands such as removing a running container from an access list, and/or removing a container endpoint from a server list.

In some embodiments of the present disclosure, selecting the optimal host node from the set of host nodes for deployment of the container may be based on various factors. These factors may include an average amount of time required to deploy the container on the node, a destruction start time of a first container deployed on the node, an average amount of time required to destroy the first container deployed on the node, a future destruction start time of a second container deployed on the node, and/or an average amount of time required to destroy the second container deployed on the node.

A system in accordance with the present disclosure may include a memory and a processor in communication with the memory. The processor may be configured to perform operations. The operations may include identifying a priority of a workload and calculating a workload preference based on the priority. The operations may include selecting a host for the workload using the workload preference and deploying the workload to the host.

In some embodiments of the present disclosure, the operations may include determining the priority based on an execution time length for the pending container provision request. In some embodiments, the operations may include determining the priority based on a container deployment time. In some embodiments of the present disclosure, the operations may include determining the priority using a time factor, wherein the time factor is selected from the group consisting of a container deployment time for the workload and an execution time length for the workload.

In some embodiments of the present disclosure, the operations may include identifying a current launch time for a first host option, generating a future launch time for a second host option, and comparing the future launch time to the current launch time to select the host. In some embodiments, the operations may include quantifying a future available resource of the host at a predetermined future time. In some embodiments, the operations may include summing a deployment delay with a deployment time to generate the future launch time.

In some embodiments of the present disclosure, the operations may include quantifying a pending recycling resource amount, enumerating a subsequent recycling resource amount, and calculating a future resource availability on the host. In some embodiments, the operations may include calculating resources in use by at least one terminal container in a destruction phase on the host to quantify the pending recycling resource amount. In some embodiments, the operations may include calculating resources in use by at least one active container to enumerate the subsequent recycling resource amount, wherein the at least one active container is scheduled for destruction within a predetermined time.

In some embodiments of the present disclosure, the operations may include calculating a launch time required to commence the workload on the host by computing a destruction phase start time for an active container deployed on the host, calculating a destruction time required to destroy the active container, and calculating a deployment time required to deploy the workload on available resources.

In some embodiments of the present disclosure, the operations may include delaying the workload from deployment for a delay time within a predetermined delay period. In some embodiments, the operations may include optimizing host selection for the workload preference using the delay time.

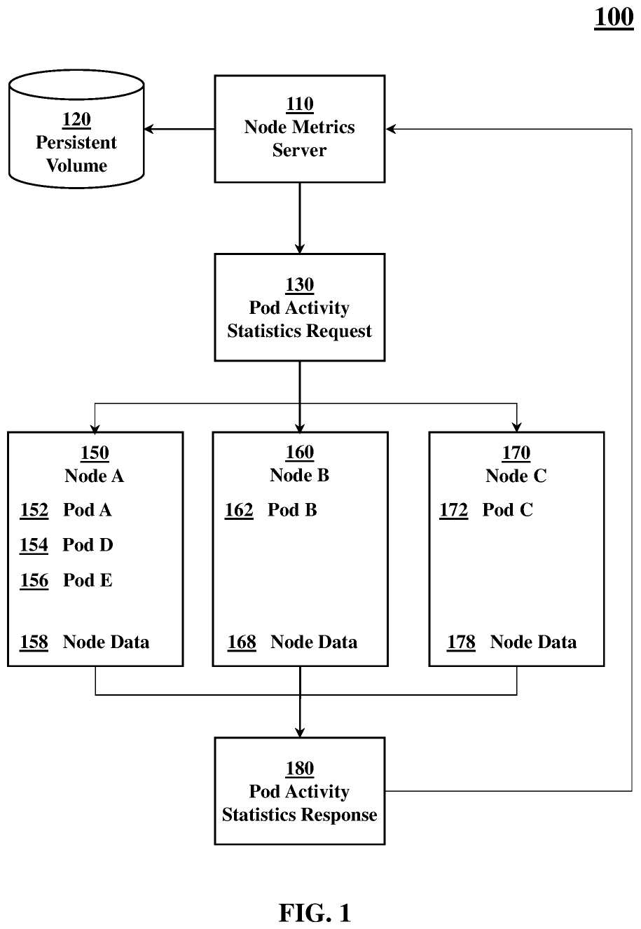

FIG. 1 illustrates a system 100 for data center resource request host selection in accordance with some embodiments of the present disclosure. The system 100 includes a node metrics server 110, a persistent volume 120, a request 130 for pod activity statistics, nodes with pods, and a response 180 to the request 130 for pod activity statistics.

The node metrics server 110 communicates with the persistent volume 120 and may write statistics on the persistent volume 120. The node metrics server 110 may submit a request 130 for pod activity statistics to each of the nodes. Node A 150 may host pod A 152, pod D 154, and pod E 156 and have the statistics for the activity for each of the pods saved as node data 158. Node B 160 may host pod B 162 and have the statistics for the activity of pod B 162 saved as node data 168. Node C 170 may host pod C 172 and have the statistics for the activity of pod C 172 saved as node data 178.

The nodes may submit a response 180 to the request 130 for pod activity statistics to the node metrics server 110. The node metrics server 110 may write the response 180 onto the persistent volume 120. The node metrics server 110 may submit a request 130 for pod activity statistics repeatedly over a period of time, and the nodes may each submit a response 180 to the request 130 and the node metrics server 110 may write the information on the persistent volume 120. For example, an administrator may task the node metrics server 110 to request 130 pod activity from the nodes daily over a period of seventeen days and write the information on the persistent volume; the node metrics server 110 may thus submit a request 130 for pod activity to the nodes every day for seventeen days and write the pod activity statistics response 180 to the persistent volume 120.

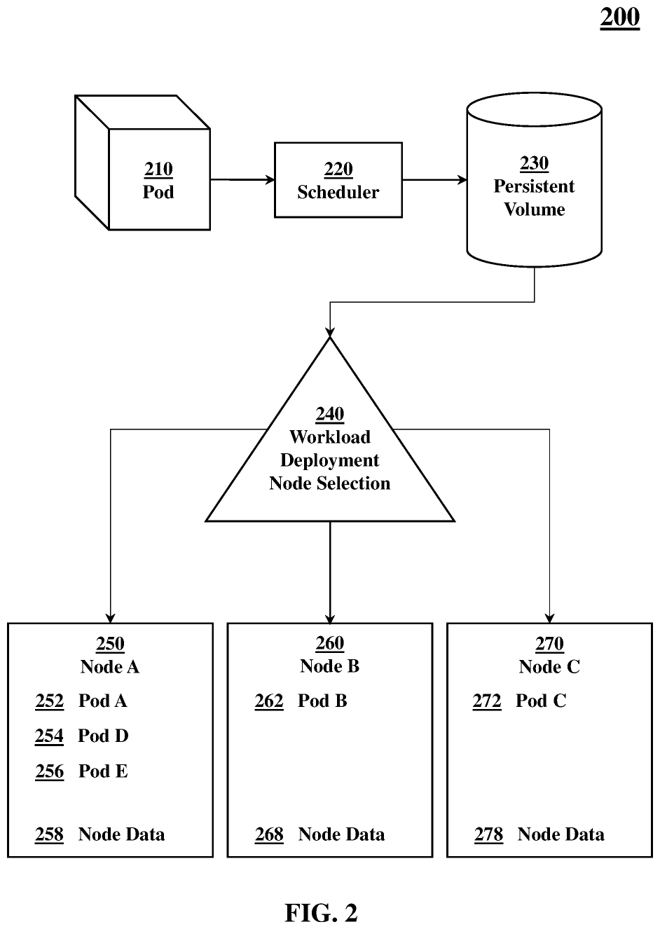

FIG. 2 depicts a system 200 for data center resource request host selection in accordance with some embodiments of the present disclosure. The system 200 includes a pod 210 pending deployment, a scheduler 220, a persistent volume 230, a workload deployment node selection component 240, and nodes which the pod 210 may potentially be deployed to.

Each node in the system 200 is shown with at least one preexisting workload. Node A 250 is running three pods, pod A 252, pod D 254, and pod E 256. Node B 260 is running one pod, pod B 262. Node C 270 is running one pod, pod C 272.

Each node also has data specific to the node such as, for example, node capacity and/or activity data about the pods hosted by the node. In the system 200 shown, the node data 258, 268, and 278 is aggregated in each node such that the statistics for all of the pods hosted by each node is stored together in the host node. In some embodiments, the pod activity data may be saved separately (e.g., node A 250 may have three distinct storage spaces to retain the data for pod A 252, pod D 254, and pod E 256, or each of the pods may store their own data internally). In some embodiments, the pod activity data in a cluster may be aggregated (e.g., stored in the control plane or otherwise separately from the tracked pods and nodes).

FIG. 2 may be used to illustrate an example. In an example in accordance with the present disclosure, node A 250 and node B 260 may be running at maximum capacity with no resources available to host any new pods and node C 270 may be running at 90% capacity and has resources available for one or more additional pods. When a pod on any node in the system 200 completes its destruction phase, the resources it used will be available for other workloads. The system 200 may track pod runtimes which may be used as an indicator of resource efficiency.

In the example, in node A 250, pod A 252 may have a deployment time (DPT) of 5 seconds, a destroy time (DST) of 14 seconds, and a runtime (RNT) of 140 seconds; pod D 254 may have a DPT of 5 seconds, a DST of 13 seconds, and an RNT of 75 seconds; pod E 256 may have a DPT of 5 seconds, a DST of 10 seconds, and an RNT of 70 seconds. In node B 260, pod B 262 may have a DPT of 7 seconds, a DST of 12 seconds, and an RNT of 100 seconds. In node C 270, pod C 272 may have a DPT of 15 seconds, a DST of 30 seconds, and an RNT of 320 seconds. Pod C 272 in node C 270 has higher time statistics for all assigned tasks DPT, DST, and RNT in comparison to the time statistics for node A 250; in other words, each task takes more time in node C 270 than it does in node A 250. The additional time for node C 270 may be necessitated by network delay, memory availability, slow processor speed, or other factor.

In this example, the system 200 may receive a workload request to deploy a new pod 210 via the scheduler 220. The scheduler 220 determines which node in the system 220 is the best host for the new pod 210. The scheduler 220 may consider the nodes with available resources to immediately host the new workload; in the example given, only node C 270 has the resources available to immediately host the new pod 210. In accordance with the present disclosure, the scheduler 220 may also consider pending availability, for example, the availability of nodes with pods pending destruction such that adequate resources will be available thereafter.

In accordance with the present disclosure, the scheduler 220 in this example may determine an optimal node for deploying the pod 210 by considering various factors such as current resource availability, future resource availability (e.g., resources that will become available within a period of time), timing of future resource availability, node statistics, workload timing needs (e.g., must be started by a certain time and/or must be completed by a certain time), workload requirements (e.g., minimum processing power), workload type (e.g., time-dependent versus processing power-dependent), and the like.

In the example, the scheduler 220 may select to deploy the pod 210 to node C 270 because the workload requires the fastest deployment possible and has a low processing power requirement such that the statistics such as slow processing power will not negatively impact the performance of the workload. Alternatively, in accordance with the present disclosure, the scheduler 220 may determine the optimal node for pod 210 is node A 250 because the priority for the workload is completion in the fastest amount of time, the workload is highly processing-power dependent, node A 250 has the best statistics of any node in the system 200, pod E 256 in node A 250 is in the destruction phase such that the resources necessary for the new pod 210 will become available within ten seconds, and deploying the new pod 210 on node A 250 would result in an estimated RNT of 80 seconds whereas deploying the new pod 210 on node C 270 would result in an estimated RNT of 170 seconds.

In accordance with the present disclosure, the system 200 may determine whether there are any currently active pods in the destroy phase and/or whether any currently active pods will complete the destruction phase within a certain period of time. For example, the system 200 may seek to deploy the new pod 210 within 25 seconds; the system 200 may identify that pod B 262 in node B 260 is in a 12 second destroy phase and that pod E 256 in node A 250 is currently active and will enter a 10 second destroy phase in 8 seconds. The scheduler 220 may identify that all of the nodes satisfy the requirements for the workload awaiting deployment; the scheduler 220 may thus select a node for the new pod 210 based on the workload type and priorities for the workload.

The total time to deployment may be calculated by adding the time it will take to deploy a workload to the amount of time until the host will have the resources available to host the workload. In this example, the total time for the deployment of the new pod 210 onto node A 250 is twelve seconds because there are 7 seconds until pod E 256 completes destruction (which will make the necessary resources available on node A 250) plus 5 seconds to deploy the new pod 210 onto node A 250. In this example, the scheduler 220 may determine that assigning the new pod 210 to node A 250 is the most efficient option. The scheduler 220 may determine this by calculating that the total time to deployment for the new pod 210 onto node A 250 is 12 seconds whereas the time to deploy the new pod 210 onto node C 270 is 15 seconds. The scheduler 220 may also consider other statistics such as, for example, RNT. In this example, the RNT for the new pod 210 if deployed to node A 250 would be 140 seconds whereas if it is deployed to node C 270 the RNT would be 320 seconds; the pod 210 will execute more quickly on node A 250, so node A 250 is a more optimal host if RNT is a priority.

In some embodiments, a pod awaiting deployment may have unknown statistics (e.g., DPT, DST, and RNT). ML statistics may be used to identify node host options and/or select an optimal host node. Certain workloads may have known statistics whereas other workloads may have unknown statistics. The system 200 may estimate the statistics of workloads, for example, using ML techniques using the statistics of similar workloads previously executed as input data.

For example, three variations of pods may be running in the nodes in the system 200 such that pod A 252, pod B 262, pod C 272, and the pod 210 awaiting deployment all have very similar workloads. The pod 210 awaiting deployment may have unknown statistics. Given the statistics of pod A 252, pod B 262, and pod C 272, an ML algorithm may be used to calculate the estimated statistics for the new pod 210 to determine an optimal node to host the pod 210.

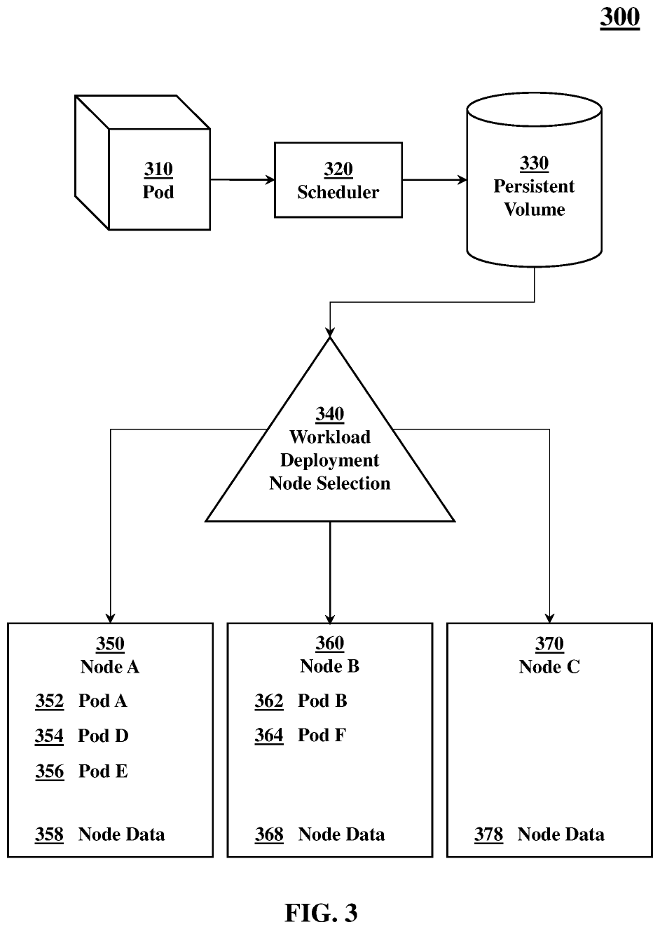

FIG. 3 illustrates a system 300 for data center resource request host selection in accordance with some embodiments of the present disclosure. The system 300 includes a pod 310 pending deployment, a scheduler 320, a persistent volume 330, a workload deployment node selection component 340, and nodes which the pod 310 may potentially be deployed to.

Two nodes in the system 300 have preexisting workloads. Node A 350 is running three pods, pod A 352, pod D 354, and pod E 356. Node B 360 is running two pods, pod B 362 and pod F 364. Node C 370 has no preexisting workloads; this could be, for example, because it was dynamically generated to host a new workload (e.g., pod 310) or because the workloads on the node had recently completed.

Each node also has data specific to the node such as, for example, node capacity and/or activity data about the pods hosted by the node. In the system 300 shown, the node data 358, 368, and 378 is aggregated in each node such that the statistics for all of the pods hosted by each node is stored together in the host node. In some embodiments, the pod activity data may be saved separately (e.g., node A 350 may have three distinct storage spaces to retain the data for pod A 352, pod D 354, and pod E 356, or each of the pods may store their own data internally). In some embodiments, the pod activity data in a cluster may be aggregated (e.g., stored in the control plane or otherwise separately from the tracked pods and nodes).

FIG. 3 may be used to illustrate an example. In an example in accordance with the present disclosure, node A 350 and node B 360 may be running at maximum capacity with no resources available to host any new pods.

Node C 370 may be running at 90% capacity and has resources available for one or more additional pods. When a pod on any node in the system 300 completes its destruction phase, the resources it used will be available for other workloads, and the system 300 may track pod runtimes and use them as an indicator of resource efficiency.

In the example, in node A 350, pod A 352 may have a DPT of 5 seconds, a DST of 14 seconds, and a RNT of 140 seconds; pod D 354 may have a DPT of 5 seconds, a DST of 13 seconds, and an RNT of 75 seconds; pod E 356 may have a DPT of 5 seconds, a DST of 10 seconds, and an RNT of 70 seconds. In node B 360, pod B 362 may have a DPT of 15 seconds, a DST of 30 seconds, and an RNT of 100 seconds; pod F 364 may have a DPT of 5 seconds, a DST of 10 seconds, and an RNT of 70 seconds. Node C 370 may not have been generated yet such that it is not yet available because it is not in the system 300.

In this example, the system 300 may receive a workload request to deploy a new pod 310 via the scheduler 320. The scheduler 320 determines which node in the system 320 is the best host for the new pod 310. The scheduler 320 may consider the nodes with available resources to immediately host the new workload; in the example given, no host is available to host the new workload request. In accordance with the present disclosure, the scheduler 320 may also consider pending resource availability, for example, the availability of nodes with pods pending destruction which will free up adequate resources when the pods complete the destruction phase.

According to the present disclosure, the scheduler 320 may compare the deployment times for deploying the new pod 310 onto newly generated node C 370 (e.g., the time it would take to dynamically generate the new node plus the time to deploy the pod 310 onto the new node C 370), deploying the pod 310 to node A 350 (e.g., the time it would take for pod E 356 to complete destruction plus the time to deploy the pod 310 onto node A 350), and deploying the pod 310 to node B 360 (e.g., the task completion for pod F 364 and its destruction time plus the time to deploy the pod 310 onto node B 360) to identify an optimal host.

In accordance with the present disclosure, the scheduler 320 in this example may determine an optimal node for deploying the pod 310 by considering various factors such as current resource availability (in the present example, a new pod would be required), future resource availability (e.g., resources that will become available within a certain predetermined period of time), timing of future resource availability (e.g., when the necessary resources will become available), node statistics (e.g., DPT, DST, and RNT numbers for similar workloads), workload timing needs (e.g., must be started and/or completed by a certain), workload requirements (e.g., minimum processing power), workload type (e.g., whether the workload is more time-dependent or more processing power-dependent), and the like.

In the example, the scheduler 320 may select to deploy the pod 310 to node B 360 because the priority of the pod 310 is the fastest deployment, node B 360 will have resources available in 13 seconds (e.g., pod F 364 may have 3 seconds until completion and will require 10 seconds to release the resources for use by another workload), node A 350 has no resource availability for 30 seconds, and it would take 25 seconds to generate node C 370.

Alternatively, in accordance with the present disclosure, the scheduler 320 may determine the optimal node for pod 310 is node A 350 because the priority for the workload is completion in the fastest amount of time, the workload is highly processing-power dependent, node A 350 has the best statistics of any node in the system 300, resources will be made available from pod E 356 in 30 seconds, and deploying the new pod 310 on node A 350 would result in an estimated RNT of 80 seconds whereas deploying the new pod 310 on node B 360 would result in an estimated RNT of 120 seconds.

In a similar example, the scheduler 320 may identify that all nodes in the system 300 are running at capacity and that both pod E 356 and pod F 364 initiated their destroy phases 3 seconds ago. According to ML statistics, both pod E 356 and pod F 364 will take approximately 10 seconds for their destruction phases on their respective nodes, so both node A 350 and node B 360 will have resources available for the pod 310 in 7 seconds.

In this example, the scheduler 320 may determine which node is more efficient. The total execution time for the new pod 310 may be calculated by summing the deployment time and runtime for the pod 310 in each node. For example, the total execution time for node A 350 may be 152 seconds (e.g., 7 seconds remaining on the destruction of pod E 356, 5 seconds for pod 310 deployment, and 140 seconds of runtime). For example, the total execution time for node B 360 may be 122 seconds (e.g., 7 seconds remaining on the destruction of pod F 364, 15 seconds for the deployment of pod 310, and 100 seconds of runtime). For example, the total execution time for node C 370 may be 357 seconds (e.g., 22 seconds to generate node C 370, 15 seconds for the deployment of pod 310, and 320 seconds of runtime). In this example, the scheduler 320 may determine that node B 360 is the optimal host because it is the most efficient host as it has the shortest total execution time.

In accordance with the present disclosure, the system 300 may determine whether there are any currently active pods in the destroy phase and/or whether any currently active pods will complete the destruction phase within a certain period of time. For example, the system 300 may be required to deploy the new pod 310 within 25 seconds; the system 300 may identify that pod B 362 in node B 360 is in a 30 second destroy phase, pod E 356 in node A 350 is currently active and will enter a 10 second destroy phase in 12 seconds, and that the system 300 can dynamically generate a new node C 370 in 35 seconds. The scheduler 320 may identify that only node A 350 satisfies the deployment time requirements and may thus select node A 350 to host the new workload of pod 310.

A computer-implemented method in accordance with the present disclosure may include identifying a priority of a workload and calculating a workload preference based on the priority. The method may include selecting a host for the workload using the workload preference and deploying the workload to the host.

In some embodiments of the present disclosure, the method may include determining the priority based on an execution time length for the pending container provision request. In some embodiments, the method may include determining the priority based on a container deployment time. In some embodiments of the present disclosure, the method may include determining the priority using a time factor, wherein the time factor is selected from the group consisting of a container deployment time for the workload and an execution time length for the workload.

In some embodiments of the present disclosure, the method may include identifying a current launch time for a first host option, generating a future launch time for a second host option, and comparing the future launch time to the current launch time to select the host. In some embodiments, the method may include quantifying a future available resource of the host at a predetermined future time. In some embodiments, the method may include summing a deployment delay with a deployment time to generate the future launch time.

In some embodiments of the present disclosure, the method may include quantifying a pending recycling resource amount, enumerating a subsequent recycling resource amount, and calculating a future resource availability on the host. In some embodiments, the method may include calculating resources in use by at least one terminal container in a destruction phase on the host to quantify the pending recycling resource amount. In some embodiments, the method may include calculating resources in use by at least one active container to enumerate the subsequent recycling resource amount, wherein the at least one active container is scheduled for destruction within a predetermined time.

In some embodiments of the present disclosure, the method may include calculating a launch time required to commence the workload on the host by computing a destruction phase start time for an active container deployed on the host, calculating a destruction time required to destroy the active container, and calculating a deployment time required to deploy the workload on available resources.

In some embodiments of the present disclosure, the method may include delaying the workload from deployment for a delay time within a predetermined delay period. In some embodiments, the method may include optimizing host selection for the workload preference using the delay time.

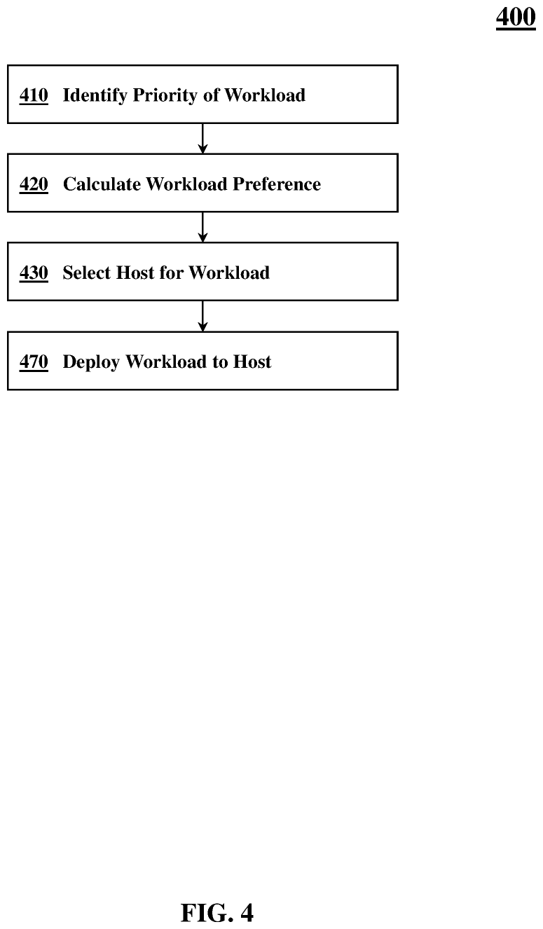

FIG. 4 depicts a computer-implemented method 400 for data center resource request host selection in accordance with some embodiments of the present disclosure. The method 400 includes identifying 410 a priority of a workload, calculating 420 a workload preference, selecting 430 a host for a workload, and deploying 470 the workload to the selected host. In some embodiments of the present disclosure, the method 400 may be performed in a distributed system (e.g., an open-sourced container system such as a Kubernetes® cluster system) by a task assignment subsystem (e.g., the data center resource host selection system 100 of FIG. 1, system 200 of FIG. 2, or system 300 of FIG. 3).

The workload priority may depend on the workload type, workload processing requirements, and similar factors. For example, a pod may have the priority of commencing its workload as soon as possible because it is a long-running and low resource consumption workload. For example, a pod may have a priority of fastest completion time of its workload.

The workload preference may be calculated with the workflow priority. For example, a workload may have a priority to complete its execution time the fastest, and calculating 420 the preference may thus conclude that the optimal host will offer the lowest number for the sum of the deployment time and runtime for this workload.

The host for the workload may be selected based on the workload preference and/or node statistics. For example, a host may be selected (e.g., using workload deployment node selection component 240 of FIG. 2) for a workload because the priority is to deploy it as soon as possible, the preference is to minimize the deployment time, and the host selected has resources available immediately. In another example, a workload may have a priority of fastest completion, so a scheduler (e.g., scheduler 320 of FIG. 3) may select a host based on the preference of minimizing the sum of the deployment time and runtime using statistics provided to the system (e.g., the node data 158, 168, and 178 submitted to the node metrics server 110 by the nodes in response 180 to the request 130 for pod activity statistics).

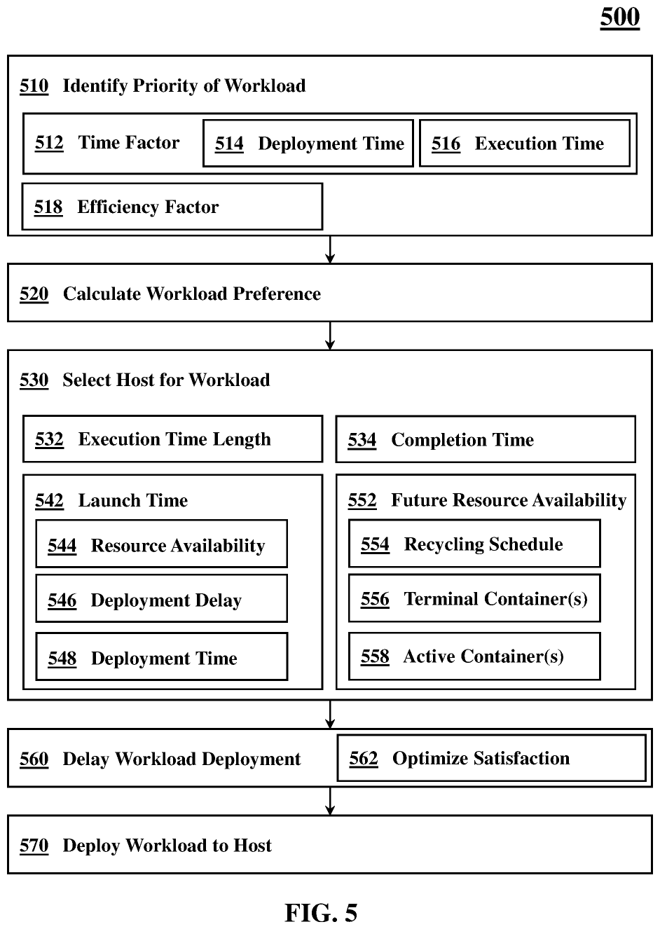

FIG. 5 illustrates a data center resource request host selection method 500 in accordance with some embodiments of the present disclosure. The method 500 includes identifying 510 a priority of a workload, calculating 520 a workload preference, selecting 530 a host for a workload, delaying 560 a workload deployment, and deploying 570 the workload to the selected host. In some embodiments of the present disclosure, the method 500 may be performed in a distributed system by a task assignment subsystem (e.g., system 100 of FIG. 1).

Identifying 510 the priority of a workload may include one or more factors such as a time factor 512, an efficiency factor 518, and other factors related to the workload. The time factor 512 may include a deployment time 514, an execution time 516, and the like. The time factor 512 may be based on pod and node statistic data (e.g., DPT, DST, and RNT).

The workload priority may depend on a command entered by a user (e.g., an administrator and/or developer), the workload type, workload processing requirements, and other factors. For example, a pod may have the priority of commencing its workload as soon as possible because it is a long-running and low resource consumption workload. For example, a pod may have a priority of fastest completion time of its workload.

Calculating 520 a workload preference may include linking the priority of the workload to the relevant statistics. The workload preference may consider one or more workload priorities. The workload preference may be calculated using the one or more workload priorities. For example, a workload may prioritize having the fastest completion time, and calculating 520 the preference may thus be to minimize the sum of the deployment time and runtime for the workload. For example, a workload priority may be to use the most efficient host which the workload may be deployed on within 30 seconds; the preference may thus be to select the host with resources available within 30 seconds that will minimize the runtime of the workload.

A host for a workload may be selected using the workload preference. Selecting 530 the host for the workload may include, for example, an execution time length 532, a completion time 534, a launch time 542, and/or a future resource availability factor 552. The execution time length 532, completion time 534, launch time 542, and future resource availability factor 552 may be calculated based on system, node, and/or pod statistics which may consider data about the workload (e.g., workload type and/or processing power requirements) seeking to be deployed.

The execution time length 532, completion time 534, launch time 542, and/or future resource availability factor 552 may each include underlying data. The launch time 542 may include resource availability 544 such as when a node will have adequate resources to host the workload. The launch time 542 may include deployment delay 546 such as how long the pod will need to be delayed for a node to host the pod. The launch time 542 may include a deployment time 548 such as how long it would take to commence a workload on a host. The deployment time 548 may be calculated by summing a destruction phase start time for an active container on the host (e.g., the amount of time until the workload is complete), a destruction time required for destroying the active container (e.g., the DST of the container), and a deployment time required to deploy the new workload on the host (e.g., the DPT of the new workload).

The future resource availability 552 may include a recycling schedule 554. A recycling schedule 554 may include one or more timeframes for when resources currently in use will no longer be in use and thus available for use by another workload; for example, a recycling schedule 554 may track the statistics of pods in a system (e.g., system 200 of FIG. 2) to identify for a scheduler (e.g., scheduler 220 of FIG. 2) when each pod in each node will complete its respective workload and complete its destroy phase such that the resources will be recycled back into availability for use. The future resource availability 552 may include information about one or more terminal container(s) 556 (e.g., pods in the destroy phase) and/or active containers 558 (e.g., pods with active workloads) so as to identify when resources will become available.

The host for the workload may be selected based on the workload preference and/or node statistics. For example, a host may be selected for a workload because the priority is to deploy it as soon as possible such that the preference is to minimize the deployment time and the host selected has resources available immediately. In another example, a workload may have a priority of fastest completion, so a host may be selected based on the preference of minimizing the sum of the deployment time and runtime using the pod and node statistics (e.g., the node data 158, 168, and 178 submitted to the node metrics server 110 by the nodes in response 180 to the request 130 for pod activity statistics).

A workload deployment may be delayed based on workload priorities, preferences, resource availability, user settings, and the like. Delaying 560 a workload deployment may include optimizing 562 the satisfaction of one or more workload priorities and/or preferences. For example, a workload may be delayed on a system (e.g., system 200 of FIG. 2) with current resource availability because the priority is to minimize runtime, the currently available host would require 320 seconds to run the workload (e.g., node C 270 of FIG. 2), and an alternate host (e.g., node A 250 of FIG. 2) which will become available in 7 seconds offers a runtime of 140 seconds; delaying 560 the workload deployment by 7 seconds to be able to deploy the workload to the alternate host would thus serve to optimize the satisfaction of the priority.

For example, a workload may be delayed on a system (e.g., system 200 of FIG. 2) with current resource availability because the preference is to minimize the time until the completion of the workload. The currently available host may require 320 seconds to run the workload (e.g., node C 270 of FIG. 2), and an alternate host (e.g., node A 250 of FIG. 2) may become available in 7 seconds and offer a runtime of 140 seconds. In this example, delaying 560 the workload deployment by 7 seconds to be able to deploy the workload to the alternate host would decrease the time until completion by 173 seconds, thus optimizing 562 the satisfaction of the preference.

The workload may be deployed to the selected host for the workload. Deploying 570 the workload may include, for example, assigning the workload to the host (e.g., node A 250 of FIG. 2) and/or launching the workload to the host such that the host may execute the workload.

A computer program product in accordance with the present disclosure may include a computer readable storage medium having program instructions embodied therewith. The program instructions may be executable by a processor to cause the processor to perform a function. The function may include identifying a priority of a workload and calculating a workload preference based on the priority. The function may include selecting a host for the workload using the workload preference and deploying the workload to the host.

In some embodiments of the present disclosure, the function may include determining the priority based on an execution time length for the pending container provision request. In some embodiments, the function may include determining the priority based on a container deployment time. In some embodiments of the present disclosure, the function may include determining the priority using a time factor, wherein the time factor is selected from the group consisting of a container deployment time for the workload and an execution time length for the workload.

In some embodiments of the present disclosure, the function may include identifying a current launch time for a first host option, generating a future launch time for a second host option, and comparing the future launch time to the current launch time to select the host. In some embodiments, the function may include quantifying a future available resource of the host at a predetermined future time. In some embodiments, the function may include summing a deployment delay with a deployment time to generate the future launch time.

In some embodiments of the present disclosure, the function may include quantifying a pending recycling resource amount, enumerating a subsequent recycling resource amount, and calculating a future resource availability on the host. In some embodiments, the function may include calculating resources in use by at least one terminal container in a destruction phase on the host to quantify the pending recycling resource amount. In some embodiments, the function may include calculating resources in use by at least one active container to enumerate the subsequent recycling resource amount, wherein the at least one active container is scheduled for destruction within a predetermined time.

In some embodiments of the present disclosure, the function may include calculating a launch time required to commence the workload on the host by computing a destruction phase start time for an active container deployed on the host, calculating a destruction time required to destroy the active container, and calculating a deployment time required to deploy the workload on available resources.

In some embodiments of the present disclosure, the function may include delaying the workload from deployment for a delay time within a predetermined delay period. In some embodiments, the function may include optimizing host selection for the workload preference using the delay time.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

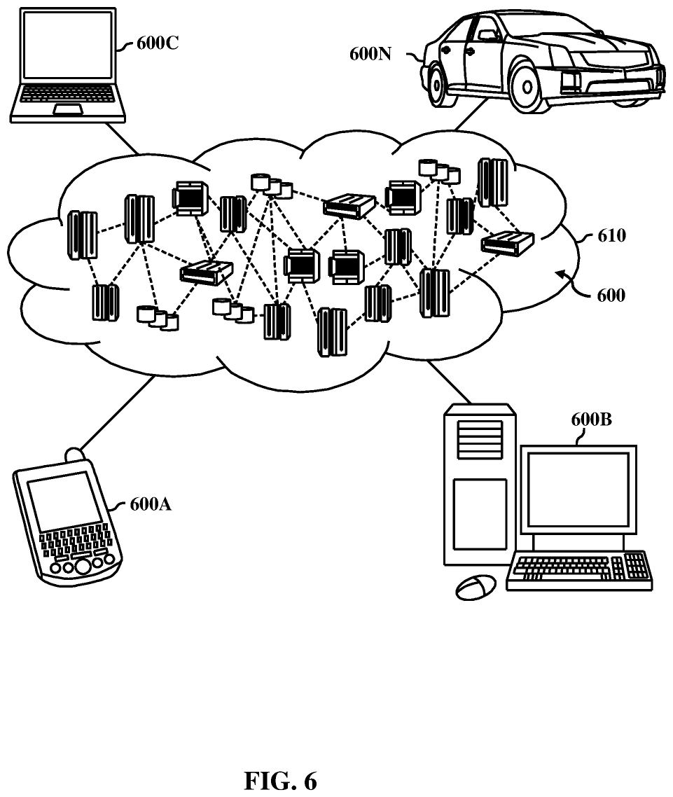

FIG. 6 illustrates a cloud computing environment 610 in accordance with embodiments of the present disclosure. As shown, cloud computing environment 610 includes one or more cloud computing nodes 600 with which local computing devices used by cloud consumers such as, for example, personal digital assistant (PDA) or cellular telephone 600A, desktop computer 600B, laptop computer 600C, and/or automobile computer system 600N may communicate. Nodes 600 may communicate with one another. They may be grouped (not shown) physically or virtually, in one or more networks, such as private, community, public, or hybrid clouds as described hereinabove, or a combination thereof.

This allows cloud computing environment 610 to offer infrastructure, platforms, and/or software as services for which a cloud consumer does not need to maintain resources on a local computing device. It is understood that the types of computing devices 600A-N shown in FIG. 6 are intended to be illustrative only and that computing nodes 600 and cloud computing environment 610 can communicate with any type of computerized device over any type of network and/or network addressable connection (e.g., using a web browser).

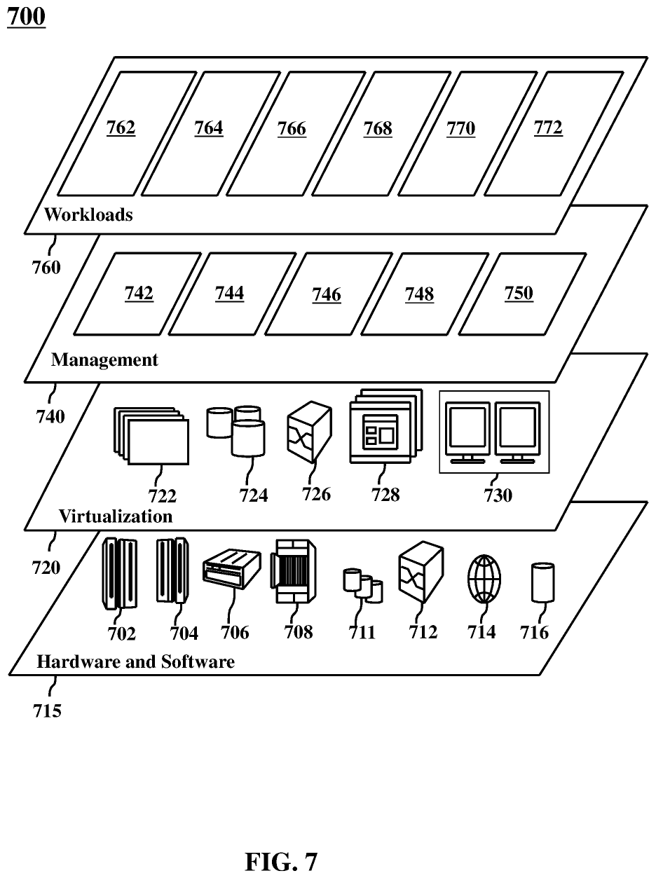

FIG. 7 illustrates abstraction model layers 700 provided by cloud computing environment 610 (FIG. 6) in accordance with embodiments of the present disclosure. It should be understood in advance that the components, layers, and functions shown in FIG. 7 are intended to be illustrative only and embodiments of the disclosure are not limited thereto. As depicted below, the following layers and corresponding functions are provided.

Hardware and software layer 715 includes hardware and software components. Examples of hardware components include: mainframes 702; RISC (Reduced Instruction Set Computer) architecture-based servers 704; servers 706; blade servers 708; storage devices 711; and networks and networking components 712. In some embodiments, software components include network application server software 714 and database software 716.

Virtualization layer 720 provides an abstraction layer from which the following examples of virtual entities may be provided: virtual servers 722; virtual storage 724; virtual networks 726, including virtual private networks; virtual applications and operating systems 728; and virtual clients 730.

In one example, management layer 740 may provide the functions described below. Resource provisioning 742 provides dynamic procurement of computing resources and other resources that are utilized to perform tasks within the cloud computing environment. Metering and pricing 744 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 746 provides access to the cloud computing environment for consumers and system administrators. Service level management 748 provides cloud computing resource allocation and management such that required service levels are met. Service level agreement (SLA) planning and fulfillment 750 provide pre-arrangement for, and procurement of, cloud computing resources for which a future requirement is anticipated in accordance with an SLA.

Workloads layer 760 provides examples of functionality for which the cloud computing environment may be utilized. Examples of workloads and functions which may be provided from this layer include: mapping and navigation 762; software development and lifecycle management 764; virtual classroom education delivery 766; data analytics processing 768; transaction processing 770; and selecting a data center workload host 772.

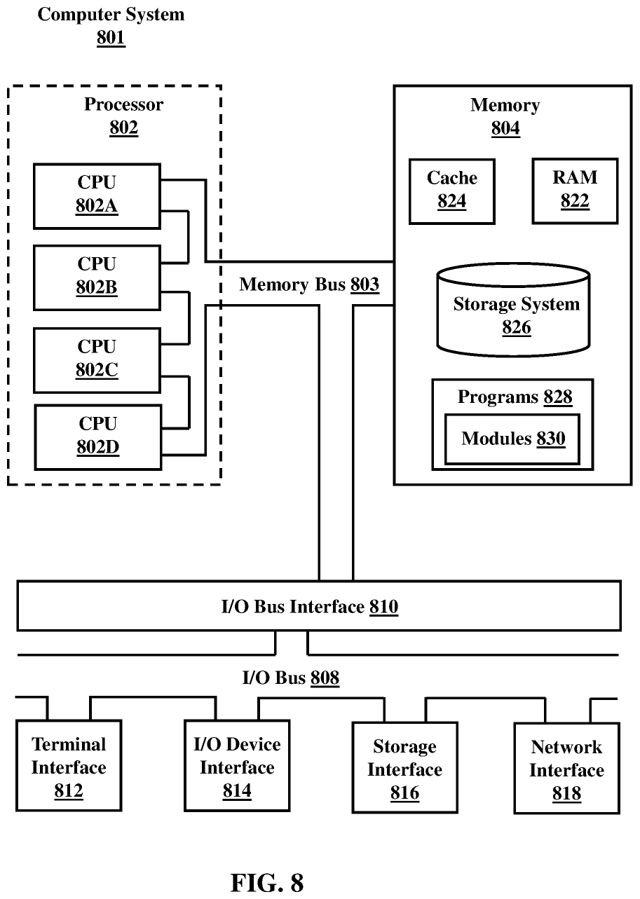

FIG. 8 illustrates a high-level block diagram of an example computer system 801 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 801 may comprise a processor 802 with one or more central processing units (CPUs) 802A, 802B, 802C, and 802D, a memory subsystem 804, a terminal interface 812, a storage interface 816, an I/O (Input/Output) device interface 814, and a network interface 818, all of which may be communicatively coupled, directly or indirectly, for inter-component communication via a memory bus 803, an I/O bus 808, and an I/O bus interface unit 810.

The computer system 801 may contain one or more general-purpose programmable CPUs 802A, 802B, 802C, and 802D, herein generically referred to as the CPU 802. In some embodiments, the computer system 801 may contain multiple processors typical of a relatively large system; however, in other embodiments, the computer system 801 may alternatively be a single CPU system. Each CPU 802 may execute instructions stored in the memory subsystem 804 and may include one or more levels of on-board cache.

System memory 804 may include computer system readable media in the form of volatile memory, such as random access memory (RAM) 822 or cache memory 824. Computer system 801 may further include other removable/non-removable, volatile/non-volatile computer system storage media. By way of example only, storage system 826 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 804 can include flash memory, e.g., a flash memory stick drive or a flash drive. Memory devices can be connected to memory bus 803 by one or more data media interfaces. The memory 804 may include at least one program product having a set (e.g., at least one) of program modules that are configured to carry out the functions of various embodiments.

One or more programs/utilities 828, each having at least one set of program modules 830, may be stored in memory 804. The programs/utilities 828 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 828 and/or program modules 830 generally perform the functions or methodologies of various embodiments.

Although the memory bus 803 is shown in FIG. 8 as a single bus structure providing a direct communication path among the CPUs 802, the memory subsystem 804, and the I/O bus interface 810, the memory bus 803 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 810 and the I/O bus 808 are shown as single respective units, the computer system 801 may, in some embodiments, contain multiple I/O bus interface units 810, multiple I/O buses 808, or both. Further, while multiple I/O interface units 810 are shown, which separate the I/O bus 808 from various communications paths running to the various I/O devices, in other embodiments some or all of the I/O devices may be connected directly to one or more system I/O buses 808.

In some embodiments, the computer system 801 may be a multi-user mainframe computer system, a single-user system, a server computer, or similar device that has little or no direct user interface but receives requests from other computer systems (clients). Further, in some embodiments, the computer system 801 may be implemented as a desktop computer, portable computer, laptop or notebook computer, tablet computer, pocket computer, telephone, smartphone, network switches or routers, or any other appropriate type of electronic device.

It is noted that FIG. 8 is intended to depict the representative major components of an exemplary computer system 801. In some embodiments, however, individual components may have greater or lesser complexity than as represented in FIG. 8, components other than or in addition to those shown in FIG. 8 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
identifying a priority of a workload;
calculating a workload preference based on said priority;
selecting a host for said workload using said workload preference; and
deploying said workload to said host.

2. The system of claim 1, said operations further comprising:
determining said priority using a time factor, wherein said time factor is selected from the group consisting of a container deployment time for said workload and an execution time length for said workload.

3. The system of claim 1, said operations further comprising:
identifying a current launch time for a first host option;
generating a future launch time for a second host option; and
comparing said future launch time to said current launch time to select said host.

4. The system of claim 1, said operations further comprising:
quantifying a pending recycling resource amount;
enumerating a subsequent recycling resource amount; and
calculating a future resource availability on said host.

5. The system of claim 1, said operations further comprising:
calculating a launch time required to commence said workload on said host by computing a destruction phase start time for an active container deployed on said host, a destruction time required to destroy said active container, and a deployment time required to deploy said workload on available resources.

6. The system of claim 1, said operations further comprising:
delaying said workload from deployment for a delay time within a predetermined delay period.

7. A computer-implemented method, said method comprising:
identifying a priority of a workload;
calculating a workload preference based on said priority;
selecting a host for said workload using said workload preference; and
deploying said workload to said host.

8. The computer-implemented method of claim 8, further comprising:
determining said priority using a time factor, wherein said time factor is selected from the group consisting of a container deployment time for said workload and an execution time length for said workload.

9. The computer-implemented method of claim 8, further comprising:
identifying a current launch time for a first host option;
generating a future launch time for a second host option; and
comparing said future launch time to said current launch time to select said host.

10. The computer-implemented method of claim 8, further comprising:
quantifying a pending recycling resource amount;
enumerating a subsequent recycling resource amount; and
calculating a future resource availability on said host.

11. The computer-implemented method of claim 10, further comprising:
calculating resources in use by at least one terminal container in a destruction phase on said host to quantify said pending recycling resource amount; and
calculating resources in use by at least one active container to enumerate said subsequent recycling resource amount, wherein said at least one active container is scheduled for destruction within a predetermined time.

12. The computer-implemented method of claim 8, further comprising:
calculating a launch time required to commence said workload on said host by computing a destruction phase start time for an active container deployed on said host, a destruction time required to destroy said active container, and a deployment time required to deploy said workload on available resources.

13. The computer-implemented method of claim 8, further comprising:
delaying said workload from deployment for a delay time within a predetermined delay period.

14. The computer-implemented method of claim 13, further comprising:
optimizing host selection for said workload preference using said delay time.

15. A computer program product, said computer program product comprising a computer readable storage medium having program instructions embodied therewith, said program instructions executable by a processor to cause said processor to perform a function, said function comprising:
identifying a priority of a workload;
calculating a workload preference based on said priority;
selecting a host for said workload using said workload preference; and
deploying said workload to said host.

16. The computer program product of claim 15, said function further comprising:
determining said priority using a time factor, wherein said time factor is selected from the group consisting of a container deployment time for said workload and an execution time length for said workload.

17. The computer program product of claim 15, said function further comprising:
identifying a current launch time for a first host option;
generating a future launch time for a second host option; and
comparing said future launch time to said current launch time to select said host.

18. The computer program product of claim 15, said function further comprising:
quantifying a pending recycling resource amount;
enumerating a subsequent recycling resource amount; and
calculating a future resource availability on said host.

19. The computer program product of claim 15, said function further comprising:
calculating a launch time required to commence said workload on said host by computing a destruction phase start time for an active container deployed on said host, a destruction time required to destroy said active container, and a deployment time required to deploy said workload on available resources.

20. The computer program product of claim 15, said function further comprising:
delaying said workload from deployment for a delay time within a predetermined delay period.
